(19) United States
(12) Patent Application Publication
(10) Pub. No.: US 2025/0099982 A1
(43) Pub. Date: Mar. 27, 2025

(54) SOLID BOWL CENTRIFUGE AND METHOD FOR REGULATING THE SEPARATION PROCESS OF THE SOLID BOWL CENTRIFUGE

(71) Applicant: GEA WESTFALIA SEPARATOR GROUP GMBH, Oelde (DE)

(72) Inventor: Martin OVERBERG, Herzebrock-Clarholz (DE)

(21) Appl. No.: 18/727,744

(22) PCT Filed: Jan. 5, 2023
(86) PCT No.: PCT/EP2023/050173

§ 371 Date: Jul. 10, 2024

(30) Foreign Application Priority Data
Jan. 11, 2022 (DE) 10 2022 100 511.9

(51) Int. Cl. B04B 11/02; B04B 1/20; B04B 7/02

(52) U.S. Cl. CPC B04B 11/02; B04B 1/20; B04B 7/02; B04B 2001/2041; B04B 2001/2083

(57) ABSTRACT

A solid bowl centrifuge includes a screw that rotates during operation, a solid material discharge, and at least one liquid outlet, which has a device for influencing an immersion depth in the separation chamber or the diameter of a separation zone in the separation chamber. The device includes one or more pressure chambers, into which a respective fluid supply line feeds, via which a gas pressure in the respective pressure chamber can be influenced such that, in the respective pressure chamber, the gas pressure is to be applied to at least one liquid surface of the exiting liquid phase, in order to influence the diameter, the immersion depth, and/or the diameter of the separation zone in the drum during operation. Respective pressure chambers are formed in the rotor. One or more functional discs are arranged in the region of the respective pressure chamber and all rotate along with the rotor.

### BACKGROUND AND SUMMARY OF THE INVENTION

Exemplary embodiments of the invention relate to a solid bowl centrifuge, in particular a two-phase or three-phase solid bowl centrifuge (also called two-phase or three-phase decanter) and to a method for regulating the separation process with such a centrifuge.

A two-phase decanter is used to clarify a suspension of solids to be processed. This means that a liquid phase and a solids phase are discharged from the bowl. It is known to change the pond depth in the bowl during operation. The term “pond depth” refers to the radial depth of the liquid layer in the area of the liquid drain. Traditionally, the pond depth is set using weir discs. The pond depth is determined by the (overflow) diameter of the installed weir discs. The decanter must be stopped to change the pond depth.

WO 03/074 185 A1, on the other hand, shows a three-phase decanter with which two liquid phases and one solid phase can be discharged from the bowl. The discharge quantity of the heavier liquid phase can be adjusted with a weir. In a three-phase decanter, the radial zone in which two liquid phases separate from each other in the centrifugal field is referred to as the separation zone. It is also known to discharge the heavy phase by means of mechanically adjustable elements during operation (see, for example, DE 10 2018 105 079 A1).

It is known from DE 10 2005 027 553 A1 that the pond depth or, optionally, the separation zone can be set using pneumatic pressure in the area of the liquid outlet. This has proven itself, but it is desirable to further reduce the additional energy consumption that this solution entails.

The invention has the object of solving this problem.

According to an embodiment, a solid bowl centrifuge is provided, which has a rotor or a system rotating during operation with a bowl rotating during operation, which has an inlet for a suspension to be processed in the centrifugal field and a separation chamber in which a screw rotating during operation is arranged. The bowl has a solid material discharge for discharging a solids phase, preferably in the region of one axial end of the bowl, and a liquid outlet for letting out at least one liquid phase in the region of the other axial end of the bowl. The one or more liquid outlets have a device for influencing, in particular for controlling or regulating, the liquid level in the separation chamber, wherein this device has one or more pressure chamber(s) that are connected via a common chamber, into each of which a fluid supply line opens, via which the pressure in the respective pressure chamber can be influenced in order to be able to apply a gas pressure to at least one liquid surface of the discharged liquid phase in the respective pressure chamber or to also apply a gas pressure during operation in order to influence a separation zone and/or a pond depth in the bowl during operation, in particular to adjust it in a controlling or regulating manner, wherein the respective pressure chamber is formed in the rotor, and wherein one or more functional discs are arranged in the region of the respective pressure chamber, wherein all of these functional discs rotate with the rotor during operation.

With the present invention, the pond depth is again set via a pneumatic pressure in the area of the liquid drain. This pressure is applied to the liquid surface in a pressure chamber that rotates with the bowl. Since one or more functional discs are arranged in the area of the pressure chamber, wherein all of these functional discs rotate with the rotor during operation, no major energy losses due to friction occur on these discs, unlike on functional discs that are stationary during operation and immersed in a rotating liquid.

A gas pressure is a pneumatically acting pressure. In particular, pressurized air or an inert gas can be used to generate the gas pressure in the respective pressure chamber.

In a preferred embodiment, the pressure chambers can be designed in such a way that they extend into the respective weir openings and are connected to a further common annular pressure chamber and are supplied with gas pressure via this.

In this respect, it is particularly advantageous if all functional discs on/in the pressure chamber or chambers (e.g., a weir disc or a siphon disc) are attached to the bowl or the screw and thus have the same rotational speed. This reduces the energy losses that occur in the known designs due to one or more, in particular a stationary siphon disc, being immersed in the liquid rotating at bowl speed.

The term “functional disc” should not be defined too narrowly. Such a disc can be designed as a one-piece or multi-piece circumferential and circumferentially closed ring disc, but it can also consist of one or more segments, in particular ring segments, and, for example, delimit only one or more of the entire weir openings or the like provided in the circumferential direction.

In addition, shaft run-on generally occurs on stationary discs which, depending on the design, can escape as leakage or return to the liquid level. However, since no stationary functional discs are immersed in the liquid, shaft run-on does not occur according to the invention and therefore cannot become a problem.

It may be provided that the one or more functional discs are non-rotatably connected to either the bowl or the screw so that they rotate with the bowl or the screw during operation. It is true that the screw can have a differential speed to the bowl. However, this is usually relatively small and therefore does not lead to a disadvantageously large energy loss.

Energy losses are kept particularly low if, according to one variant, the pressure chamber is bounded on all sides only by elements that rotate with the rotor during operation.

The invention is suitable for both two-phase decanters (liquid/solid separation) and three-phase decanters (liquid/liquid/solid separation), with the latter having two liquid outlets for two liquid phases of different densities-a lighter liquid phase and a heavier liquid phase. Depending on the design, it is then possible to adjust either the pond depth and/or the separation zone.

The invention can be used for various types of liquid discharge (free discharge, internal or external paring disc, paring tube) or liquid discharge. The possibility of adjusting the pond depth during operation is always advantageous.

In addition, the arrangement of the new functional discs to form the pressure chambers can be implemented cost-effectively.

Variants in which the at least one liquid outlet has a weir with one or more weir openings and in which one or more pressure chambers are assigned to the weir can be realized particularly well and cost-effectively.

According to a further preferred embodiment, it may also be provided that several of the weir openings are provided in the bowl cover, and that a first siphon disc extending from radially inwards to outwards into the area of the weir openings is connected upstream of the one or more weir openings as one of the functional discs. This defines a respective first siphon, which is formed between the separating chamber and the respective weir opening with a downstream first weir disc.

According to a particularly preferred embodiment, it may be provided that the fluid supply line has at least two line sections, wherein one of these line sections is formed in the non-rotating region of the solid bowl centrifuge and wherein the other of these line sections or a plurality of these second line sections is formed in the rotor and opens into one or more pressure chambers in the rotor.

It is then appropriate and advantageous if the pipe section of the fluid supply line in the non-rotating area of the solid bowl centrifuge and the pipe section in the rotor are connected to each other via a rotary feedthrough.

The pressure thus passes through a rotary feedthrough with one or more seals into the rotating annular part of the pressure chamber on the bowl and can be adjusted in height during operation. This allows the pond depth to be changed continuously without stopping the bowl.

In particular, it may be provided that
the one or more liquid outlets for the light liquid phase are each assigned one of the pressure chambers that are connected to the annular part of the pressure chamber into which the fluid supply line opens in the rotor,
and/or that the one or more liquid outlets for the heavy liquid phase are each assigned one of the pressure chambers that are connected to the annular part of the pressure chamber into which the fluid supply line opens in the rotor.

Depending on the design, the pond depth and/or the separation zone diameter in the separation chamber can thus be easily influenced.

The control or regulation of the pond depth and/or the separation zone diameter is/are preferably carried out via a control unit of the centrifuge, which is equipped with a corresponding control and/or regulation program.

This means that the pond depth and/or optionally the position of the separation zone is set via pneumatic pressure in the area of the respective liquid drain. This pressure is applied to the liquid surface in a chamber that rotates with the bowl. The pressure enters the rotating chamber on the bowl via a seal and can be adjusted during operation. This allows the pond depth to be changed continuously without stopping the bowl. This type of pond depth adjustment can be used with both 2-phase and 3-phase decanters.

By changing the pressure in the pressure chamber(s), the pond depth in the separation chamber can be adjusted and/or the separation zone in the bowl can be moved easily, which also leads to a change in the liquid level. A conversion that would otherwise be necessary due to changes in the properties of the product can generally be omitted by utilizing the given regulation range. The design effort required to create the pressure chamber(s) is low.

The overflow for the other phase, if applicable, can be realized, for example, by radial discharge pipes that pass through the bowl shell or cover radially to the outside.

According to an advantageous variant, for example, it may be provided that the one or more liquid outlets for the lighter liquid phase are each assigned one of the pressure chambers, which are connected via a common annular pressure chamber into which a fluid supply line opens in the rotor, and that the one or more liquid outlets for the heavier liquid phases are each assigned a discharge pipe with which the heavier liquid phase can be discharged from the bowl. This is easy to implement in terms of design.

However, according to another variant, it may also be advantageously provided that one of the pressure chambers is assigned to each of the one or more liquid outlets for the heavier liquid phase, which are connected via a common annular pressure chamber into which a fluid supply line opens in the rotor, and that the one or more liquid outlets for the lighter liquid phase are each assigned a discharge pipe with which the lighter liquid phase can be discharged from the bowl. This is also easy to implement in terms of design.

Three-phase designs open up a new possibility, e.g., to have the gas pressure act alternatively on the phase discharged via tubes or nozzles.

The invention also provides a method for operating a solid bowl centrifuge according to one of the claims relating thereto, in which a control gas is fed through a rotary feedthrough into the rotating system and there into one or more pressure chamber(s) rotating during operation. The regulation of the separation process in the bowl can then include, for example, setting the pressure in the pressure chamber as a control variable.

It is also conceivable that the regulation of the separation process in the bowl includes a change in the speed of the bowl as an additional control variable.

In addition, the separation process in the bowl can be regulated depending on the concentration in the solids phase or in one or both derived liquid phases.

### BRIEF DESCRIPTION OF THE DRAWING FIGURES

In the following, the invention is described in more detail with reference to the drawing by means of exemplary embodiments. The invention is not limited to these exemplary embodiments, but can also be implemented differently within the scope of the claims. In addition, individual features of the following exemplary embodiments can also be combined with other exemplary embodiments, wherein:

FIG. 1 shows a schematized sectional view of a partial area of a first solid bowl centrifuge according to the invention;

FIG. 2 shows a schematic sectional view of a partial area of a second solid bowl centrifuge according to the invention;

FIG. 3 shows a schematic sectional view of a partial area of a third solid bowl centrifuge according to the invention;

FIG. 4 shows a schematic sectional view of a partial area of a fourth solid bowl centrifuge according to the invention;

FIG. 5 shows a schematic sectional view of a partial area of a fifth solid bowl centrifuge according to the invention;

FIG. 6 shows a schematic sectional view of a partial area of a sixth solid bowl centrifuge according to the invention; and

FIG. 7 shows a schematic, section-like view of the first solid bowl centrifuge according to the invention;

The terms “right”, “left”, “horizontal” and “vertical” used in the following refer to the respective drawing level.

### DETAILED DESCRIPTION

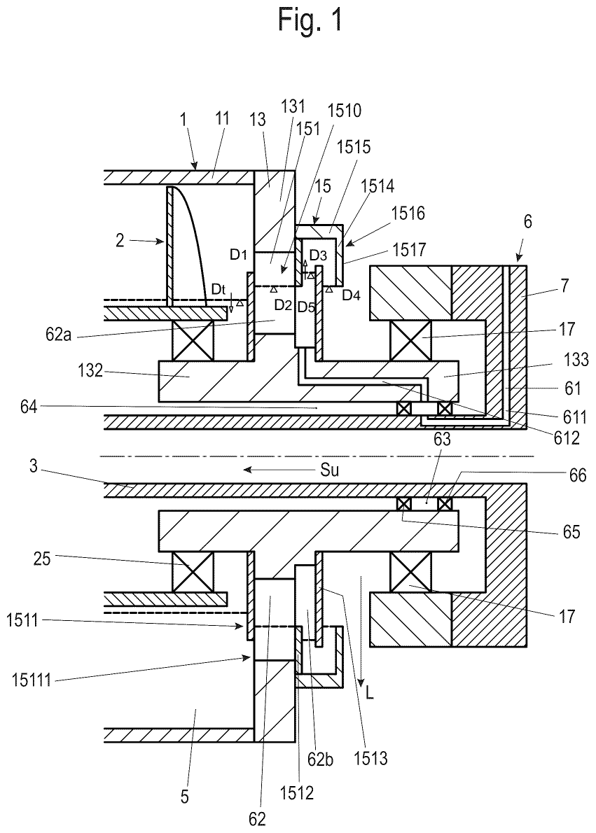

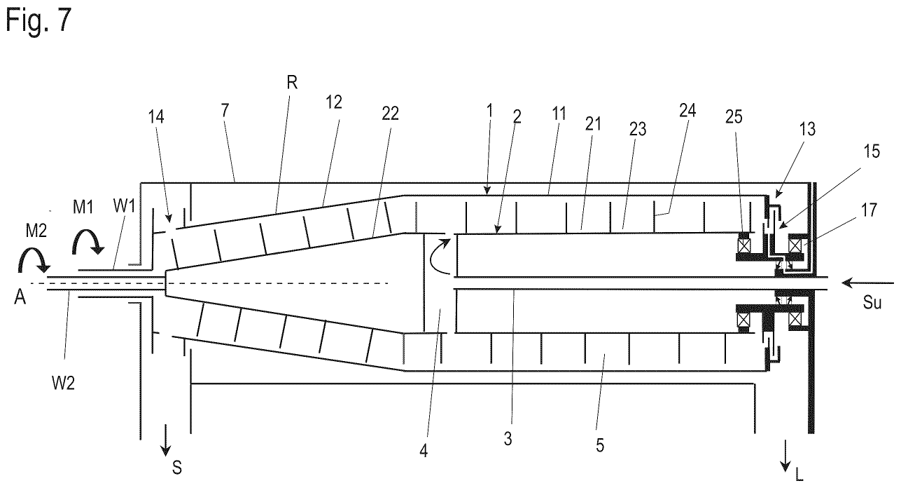

FIG. 7 shows a first solid bowl centrifuge. This illustration serves on the one hand to illustrate a variant of the invention and on the other hand to illustrate the basic principle of a solid bowl centrifuge, in order to give an example of a solid bowl centrifuge in which the invention can be implemented as illustrated or in another way. For example, one or more or all of the features and methods shown in FIGS. 1 to 6 can also be advantageously implemented in the solid bowl centrifuge of FIG. 7.

The solid bowl centrifuge in FIG. 7 is equipped with a frame 7, which cannot rotate or is stationary on a foundation or similar during operation, and a rotor R, which can rotate or rotates during operation.

The rotor R has a rotatable bowl 1 with a horizontal axis of rotation A. However, the axis of rotation A can also be oriented differently, in particular vertically, in space. The rotor R also includes a screw 2 arranged in the bowl 1, the axis of rotation of which coincides with the axis of rotation of the bowl 1.

The bowl 1 has an internally and externally cylindrical section 11 and an axially adjoining internally and externally conical section 12. The cylindrical section 11 is closed by a substantially radially extending bowl cover 13.

The screw 2 here also has an at least externally cylindrical section 21 and an axially adjoining at least externally conical section 22. It is arranged inside the bowl 1. The bowl 1 is rotatable during operation. The screw 2 can also be rotated during operation. Preferably, the two elements bowl 1 and screw 2 are rotated at a differential speed to each other during operation. One or more corresponding drives, e.g., electric motors and/or gears (not shown here), which feed a torque M1, M2 for rotating the bowl or screw into shafts W1, W2, which are connected directly or indirectly via a gear (not shown) to the bowl 1 or screw 2 in a rotation-tested manner, are used for rotation. The screw 2 also has a screw body 23 and a screw helix 24 extending radially outwards from this, which does not touch the inner wall of the bowl.

A baffle plate can be provided on the screw body 23 towards the conical section of the screw.

The drive rotates the bowl 1 on the one hand and the screw 2 on the other.

The bowl 1 is rotatably mounted at both of its axial ends with one or more bowl bearing(s) 17 arranged axially in the direction of the axis of rotation, in particular rotatably mounted on the frame. For the sake of simplicity, only one of the bowl bearings—the bowl bearing 17 close to the cylindrical section 11 of the bowl 1—is shown here.

The screw 2 is also rotatably mounted on the frame 7 at both of its axial ends with one or more screw bearings 25 arranged axially in the direction of the axis of rotation. For the sake of simplicity, only one of the screw bearings 25—at the end of the cylindrical section 22 of the screw 2—is shown here.

The bowl 1 and/or the screw 2 can also be mounted on one side, in particular with the axis of rotation A aligned vertically (not shown).

In this respect, the term “bearing” should not be defined too narrowly. Each of the bearings 17, 25 can consist of one or more individual bearings, which are then arranged axially directly next to each other so that they can each be considered functionally as a single bearing. The bearings 17, 25 can also be designed as bearings of various types, for example as rolling bearings—in particular as ceramic bearings, as hybrid ceramic bearings, as magnetic bearings, or as plain bearings.

The bowl bearing or bowl bearings 17 are arranged between the bowl 1 and the frame 7 or a part connected to the frame 7, so that the bowl 1 can be rotated relative to the frame 7. The bowl bearings 17 are preferably arraMicrosoft Teams nged radially between the bowl 1 and the frame 7 or a part connected to the frame. The one screw bearing 25, on the other hand, can be arranged between the bowl cover 13 and the frame 7, for example.

Here, the bowl cover 13 has a substantially radially extending section 131 and two axial sections 132, 133 extending to opposite sides—in this case away from the inner end of the section 131 (see FIG. 1).

The axial sections 132, 133 can each be used to arrange one of the bowl bearings 17 or the screw bearings 25 and can be used on one or more collars or the like to arrange further elements such as functional discs.

The bowl cover 13 rotates with the bowl 1 in a rotationally fixed manner.

A feed pipe 3 extends into the bowl 1, concentrically to the axis of rotation, and opens into a distributor 4, through which a suspension Su to be processed can be fed radially into a separation chamber 5 in the bowl 1. In this exemplary embodiment, the feed pipe 4 is firmly connected to the frame 7.

The feed pipe 4 can either be guided into the bowl 1 from the side of the cylindrical bowl section 11 or it can be guided into the bowl 1 from the side of the conical bowl section 12.

The bowl 1 is designed as a solid shell bowl. In the rotating bowl 1, at least one incoming suspension Su is clarified of solids S and the liquid portion clarified of solids is either discharged as a liquid phase L or optionally separated into at least two liquid phases Ll and Lh of different densities.

The solids phase or the solids S are transported by the screw 2 in the direction of a solids discharge 14 in the conical section 12 of the bowl 1 and ejected from the bowl 1 there. The at least one liquid phase L thus exits the liquid drain 15 through the bowl cover 13.

At the end of the cylindrical section 11 facing the bowl cover 13 and/or on the bowl cover 13, one or more liquid drains 15, 16 . . . of the first type and of the second type for one or more liquid phases Ll and/or Lh of different densities. These can each be provided once or several times.

In FIGS. 7 and 1, according to one embodiment, only a single type of liquid drain 15 is provided, which is formed in the bowl cover 13. This will be discussed in more detail below.

For this purpose, the bowl cover 13 can be provided with a ring-like weir opening—possibly except for spokes (not shown here) between an inner and an outer section of the bowl cover 13—or two or more weir openings 151, preferably distributed circumferentially on a common radius, which pass through it axially. In an axial plan view of the bowl cover 13, however, the weir openings can be circular or, for example, also arcuate.

A device 6 for influencing, in particular for controlling or regulating the liquid level in the separation chamber 5—here via a pneumatic pressure—which acts on one or more liquid surfaces of the liquid phase L in the pressure chamber, is assigned to the weir opening(s) 151.

FIG. 1 shows a first exemplary embodiment of the possible design of the area of the bowl cover 13 in particular and the—here only one—type of liquid drain 15 of the solid bowl centrifuge, as it can be used in the centrifuge of FIG. 7.

The device 6 for influencing, in particular for controlling or regulating—the liquid level—and optionally a separation zone—in the separation chamber 5, as shown in FIG. 7, is also assigned to the weir opening or openings 151 in FIG. 1. This has a fluid supply line 61 with which a fluid, in particular a gas, can be fed from a fluid reservoir (not shown) or the like outside the rotor into a respective pressure chamber 62 in the area of the respective liquid outlet 15 in order to generate a gas pressure there which acts on the respective liquid surface. For each weir opening 151, the pressure chamber 62 has a first pressure chamber section 62a within the respective weir openings 151 and a circumferentially annular pressure chamber section 62b, which is axially connected thereto towards the outside and which can be formed circumferentially on the inside on the side of the second siphon disc 1513 directed towards the weir openings 151 and radially on the outside towards the ring cup 1517 and connects the first pressure chamber sections 62a. The fluid supply line 61 can preferably open into the circumferential annular pressure chamber section 62b, since the entire pressure chamber 62 can thus be pressurized with gas with a single supply line.

When controlling or regulating the centrifugal separation process in the bowl, the gas pressure is adjusted here and according to the further figures in the respective pressure chamber 62, into which a gas is introduced that is fed through a rotary feedthrough into the rotor of the bowl and there into the respective pressure chamber, which is preferably limited only by elements rotating during operation, which—as already explained—is favorable from an energy point of view.

In the pressure chamber 62, a gas pressure acts on at least one or more liquid surfaces of the liquid phase flowing through it at the liquid drain.

Several functional discs are assigned to the respective liquid drain 15 (or in other figures alternatively or additionally to the respective liquid drain 16 for the one liquid phase here), in this case four functional discs 1511, 1512, 1513, 1514.

A functional disc within the meaning of this application is a rotating or optionally also segment-like disc or a similar element, which has on its inner radius or its outer radius a preferably rotating or segment-like boundary edge, which can form an overflow edge for a liquid and preferably also forms such an edge during operation. The functional discs 1511, 1512, 1513, 1514 of all exemplary embodiments are each designed as discs that rotate with the rotor during operation. During centrifugal processing of a suspension, they rotate with the rotor and, in particular, with the bowl 1 or with the screw 2.

Here—and in the other figures—the functional discs 1511, 1512, 1513, 1514 are designed as discs rotating with the bowl 1. However, all or some of the functional discs 1511, 1512, 1513, 1514—here and in the other figures-could also be designed as discs rotating with the screw 2 (not shown here in each case).

Since the functional discs 1511, 1512, 1513, 1514 are thus rotated at high speed during operation and since no stationary elements are provided in the area of the liquid outlet 15 in the rotating system, past which the liquid flows in rotation, no significant or at least no such large energy losses occur in the area of the functional discs 1511, 1512, 1513, 1514 as can occur at stationary functional discs.

If one or more of the functional discs 1511, 1512, 1513, 1514 are arranged on the screw (not shown here), the differential speeds between bowl 1 and screw 2 during operation are almost negligible with regard to any energy losses due to friction in the fluid (splash losses), as the differential speeds are relatively low. The term functional discs 1511, 1512, 1513, 1514 should not be interpreted too narrowly. Such a disc can be designed as a circumferential ring disc, but it can also consist of one or more segments, in particular ring segments, and only be provided in the area of the respective weir openings.

According to the exemplary embodiment of FIG. 1, a first of the functional discs 1511 is assigned to the one or more circumferentially distributed weir openings 151 in the bowl cover 13 on its side facing the interior of the bowl or the separation chamber or is arranged upstream in the direction of flow. This can also be referred to as the inner siphon disc 1511 and it partially covers the weir openings 115 starting from their inner diameter radially outwards.

In each case, a gap 15111 remains between the outer diameter D1 of the inner siphon disc 1511 and the largest or (outer) diameter of the weir openings 151, through which liquid from the separation chamber 5 can overflow/flow over into the actual weir opening 151.

The inner or first siphon disc 1511 can be non-rotatably connected to the bowl cover 13. It can, for example, be supported axially on the inside on a radial collar or directly on the radial section of the bowl cover 13 and preferably be fixed in a rotationally fixed manner. It can consist of a circumferential ring or of a plurality of individual segments—elements which are assigned, for example, to the individual weir openings 151, between which gaps can also be formed. A type of first siphon 1510 is formed here on the inner siphon disc 1511 in the area of each weir opening 151. One side of the respective first siphon 1510 is oriented towards the separating chamber and the other side is oriented towards the respective weir opening 151 and is bounded on the outside of the weir opening 151 by a first weir disc 1512.

Downstream of the liquid drain 15 with the inner siphon disc 1511 is a type of second siphon, which can be designed as a ring siphon 1516 provided in sections, for example in the area of individual weir openings or circumferentially. This ring siphon 1516 has two functional discs 1512 and 1514—also known as weir discs—which extend radially from the outside inwards to an internal diameter D2 (inner weir disc 1512) or D4 (outer weir disc 1514) and which are connected to each other at their outer radial ends by an axial wall 1515, so that between the weir discs 1512 and 1514 and the radially outer axial wall an annular chamber or ring cup 1517 is formed, which is U-shaped in cross-section in sections or segments or continuously provided and which is open towards the inside. This ring cup 1517 directly adjoins the side of the bowl cover 13 facing away from the separating chamber. The axial wall 1515 and the outer weir disc 1514 can be connected to form an annular element with an L-shaped cross-section.

A third functional disc 1513, which extends radially from the inside to the outside and is provided in segments or continuously, projects into the inwardly open ring cup 1517-which is also referred to as the outer or second siphon disc 1513—which in turn can be connected to the bowl cover 13 in a rotationally fixed manner. For example, its inner area can rest against a collar of the outer axial section of the bowl cover 13.

The outer siphon disc 1513 extends to an outer radius/diameter D3, wherein preferably the following applies: D3>D2 and D3>D4 with D2=inner diameter of the first, inner weir disc and D4=inner diameter of the second, outer weir disc 1514.

This means that the outer siphon disc 1513 projects radially into a liquid ring or dips into it when liquid collects radially outside in the ring siphon 1516 during operation.

On the outer side of the bowl cover 13 facing away from the separation chamber 5, the inner weir disc 1512 is preferably arranged directly on the bowl cover 13 in this exemplary embodiment, which in turn can be connected to the bowl cover 13 in a rotationally fixed manner. This inner weir disc 1512 can partially cover the respective weir openings 151 radially from the outside to the inside, up to an inner diameter D2, wherein preferably the following applies: D2<D5 (inner level in the ring siphon 1516).

During operation, the liquid or liquid phase flowing from the separation chamber via the first siphon disc 1511 through the gap 15111 fills the outer area of the actual weir opening 151 up to a diameter D2 and then runs via the inner weir disc 1512 and via the pressure chamber 62 into the ring siphon 1516. The liquid then runs out of the rotating system via the outer weir disc 1514.

The fluid supply line 61 protrudes into the pressure chamber 62 formed between the inner siphon disc 1511 and the outer siphon disc 1513. The fluid supply line is initially formed in a first section 611 in the stationary system, for example in the frame 7 and/or in the inlet pipe 4.

The fluid supply line 61 also has at least one second, adjoining section 612 in the rotating or revolving system. Between the first line section 611 and the at least one or more second line section(s) 612 of the fluid supply line, a rotary feedthrough 63 for transferring fluid, in particular gas, preferably air, from the stationary system into the rotating system of the solid bowl centrifuge can be transferred.

The rotary feedthrough 63 can be formed in an annular gap 64, which can be formed radially between the rotating system and the non-rotating system, for example between the bowl cover 13, which rotates during operation, and the feed pipe 3, which is stationary during operation.

The rotary feedthrough 63 can be radially limited in the annular gap by two axially spaced seals—for example mechanical seals 65, 66—arranged in the annular gap 64. This delimits an annular chamber into which, on the one hand, the first line section 611 opens into the rotary feedthrough 63 and into which, furthermore, the respective second line section 612 opens, which extends into the respective pressure chamber 62 and opens into the latter, preferably radially inwards.

In this way, gas can be fed into the pressure chamber 62. As a result, the pressure in the respective pressure chamber 62, internally limited by the bowl cover 13 and radially limited by the inner and outer siphon disc 1511, 1513 and radially outwardly limited by fluid, can be varied during operation.

In order to ensure that the pneumatic pressure can be fed into the pressure chamber 62, which rotates with the bowl, the design of the rotary feedthrough should preferably be such that a pressure of up to 3 bar can be controlled.

Each of the weir openings 151 can be assigned one of the pressure chamber(s) 62 (FIG. 1) or only one part of the weir openings 151, 151′, which will be explained in more detail below.

The mode of operation of this arrangement is as follows.

During operation, when the bowl 1 rotates, an inner diameter Dt forms in the separation chamber 5, up to which the bowl 1 fills radially inwards with liquid. This inner diameter Dt is also referred to as the pond depth.

The clarified liquid phase L enters the pressure chamber 62 via the inner siphon disc 1511 with the outer diameter D1 (D1>Dt) and the first siphon 1510 and then into the second ring siphon 1516, from which it flows out of the rotating system or, in this case, the bowl 1. It fills this ring siphon in the area towards the bowl cover 13 radially inwards up to a diameter D5.

Two water levels D5 and D4 form in the ring siphon 1516 due to the pressure differences. At the first siphon 1510 there are the water levels Dt (pond depth) and D2 (overflow diameter of the first weir disc 1512).

By varying the pressure acting on the pressure chamber 62, which can preferably be filled radially from the inside with the supplied gas, the pond depth Dt in the bowl 1 can then be influenced or controlled or regulated.

According to FIG. 1, in a two-phase decanter for separating two phases (solid/liquid), the liquid phase L is passed through one or more pressure chamber(s) 62. The pressure imposed by the gas in the respective pressure chamber 62 influences the pond depth Dt of the liquid phase in the bowl 1. The pond depth increases with a higher gas pressure and decreases with a lower pressure.

This makes it easy to change the pond depth in the bowl of a two-phase solid bowl centrifuge.

This significantly reduces the high friction losses compared to existing systems.

It is particularly advantageous if all functional discs 1511, 1512, 1513, 1514 of the one or more pressure chambers (weir discs and siphon discs) are attached to the bowl 1 or the screw 2 and thus have the same rotational speed. This avoids the high losses (splash losses) that occur in existing designs due to the fact that a stationary functional disc, usually a siphon disc, is immersed in the liquid rotating at bowl speed.

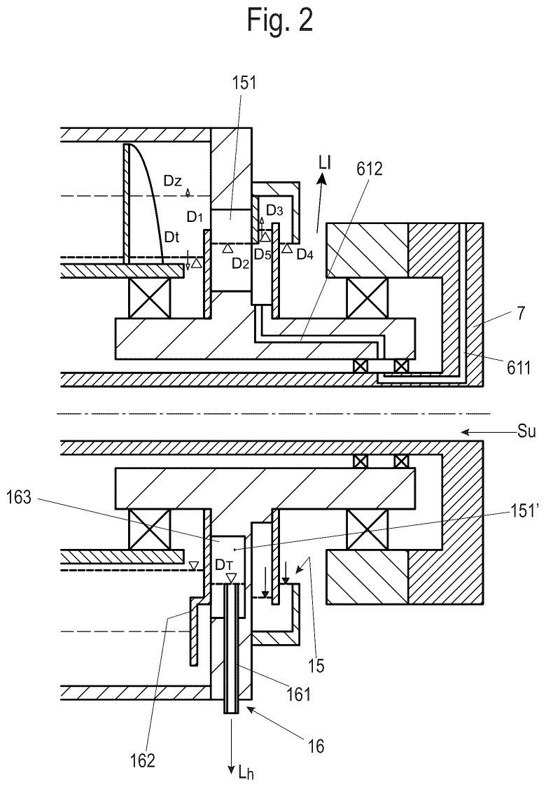

In a further embodiment variant—FIG. 2—for a decanter for separating 3 phases (solid/liquid/liquid), the structure largely corresponds to that of FIG. 1.

However, it is additionally provided to discharge a second liquid phase L from the bowl 1 with one or more second liquid outlets 16.

For this purpose, it may be provided that the second—in FIG. 2 the heavier liquid phase Lh—is led out of the bowl 1 with one or more discharge pipes 161, which are essentially radial. In this way, the two liquid phases can be discharged separately through downstream chambers and lines (not shown here).

This can be implemented in various ways, one of which is shown as an example in FIG. 2.

For example, it may be provided that some of a series of circumferentially distributed weir openings 151—e.g., every second or every third weir opening 151′—are designed in such a way that they do not completely penetrate the bowl cover 13 from the side of the separation chamber 5, but are designed like a blind hole. In this blind hole 151′, the end of a respective discharge pipe 161 can be located radially inwards, which can pass through the bowl cover 13 radially outwards. This discharge pipe ends on the inside at a diameter Dr. In this way, a discharge chamber 163 is formed with the aid of the blind hole.

A type of separating weir 162 can be integrally formed onto the respective blind hole(s), which extends into the radial area of the separation space 5 in the bowl 1 at the diameter Ds, wherein Ds>Dz (Dz=separation diameter=(boundary between the two liquid phases Ll and Lh)). In this way, the heavier phase is first discharged via the separating weir 162 into the blind hole-like weir opening 151′ and then from there through the discharge pipe 161 out of the bowl and the rotating system.

Only the lighter of the two liquid phases Ll is then passed through the pressure chamber (FIG. 2) and the heavier liquid phase Lh is discharged through the discharge pipe 161.

Depending on the pressure applied by the gas in the respective pressure chamber 161, the pond depth Dt of the two liquid phases L in the bowl 1 and the separation diameter Dz (boundary between the two liquid phases Ll and Lh) are influenced. At a higher gas pressure, the pond depth increases and the separation diameter increases, while the pond depth and the separation diameter decrease when the pressure decreases.

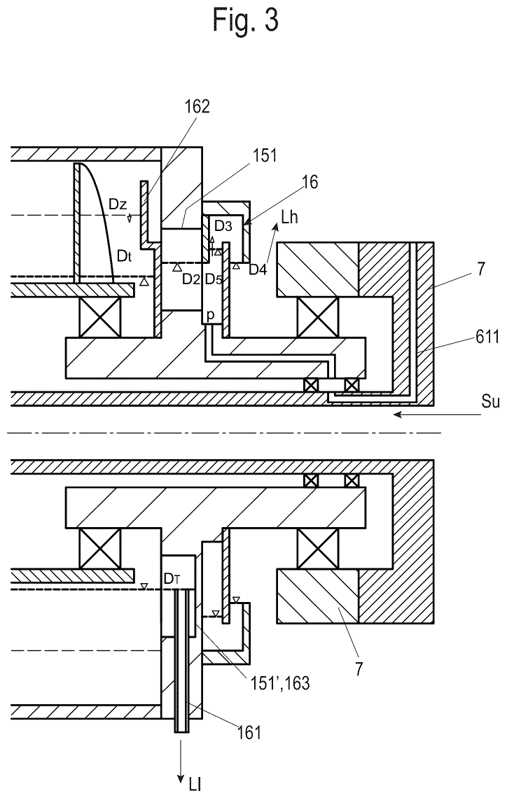

In a third embodiment variant for a decanter for separating the phases (solid/liquid/liquid), on the other hand, the heavier of the two liquid phases Lh is passed through circumferentially distributed (here collar-like) separating weirs 162 through a respective pressure chamber 62 (FIG. 3) and the lighter liquid phase is discharged through axially open blind holes 151′ on one side and discharge pipes 161 at a diameter Dr (which is equal to the pond depth here). Depending on the pressure imposed by the gas in the pressure chamber 62, the separation diameter Dz of the two liquid phases in the bowl is influenced. If the gas pressure is higher, the separation diameter Dz is reduced, and if the pressure decreases, the separation diameter Dz increases. The pond depth Dt is independent of the pressure in this case.

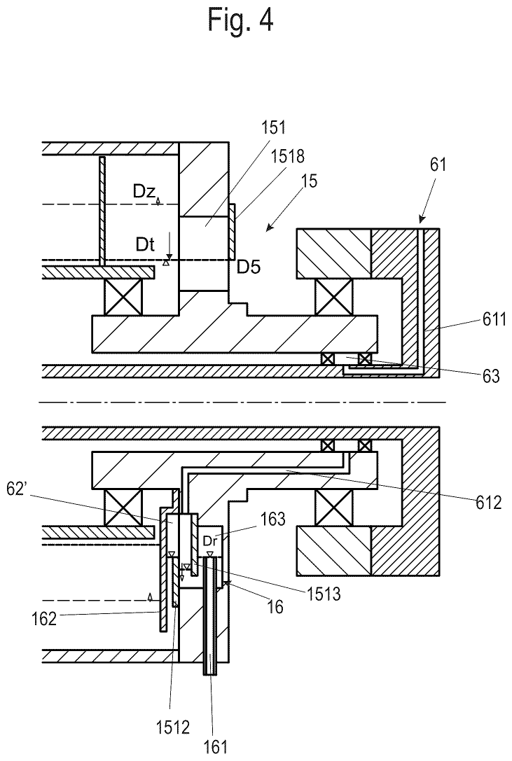

In a fourth embodiment variant (FIG. 4) for a 3-phase decanter for separating 3 phases (solid/liquid/liquid), the lighter of the two phases Ll is discharged freely via one or more overflow weirs 1518.

Thus, one or more circumferentially distributed weir openings 151 can each be followed by an overflow weir 1518 fixed to the bowl cover 13. This forms a functional disc. It defines the pond depth Dt in the separation chamber 5.

Furthermore, other blind hole-like weir openings 151′ can in turn be preceded by a type of separating weir 162, via which the heavier liquid phase Lh flows into the area of this respective blind hole 151′ with one of the discharge pipes 161. The removal of the heavier liquid phase Lh can in turn take place through one of the discharge pipes 161 from a discharge chamber 163 in the blind hole 151′ at a radius Dr.

A pressure chamber 62′, which can be provided in the area of this respective liquid outlet, is connected upstream of this discharge chamber 163 by means of several functional discs 1514, 1512 and the separating weir 162 as a functional disc. A supply line 61, the second section 612 of which runs behind a rotary feedthrough 63 in the rotating system—in this case in the bowl 1—, opens into the pressure chamber 62′.

The pressure chamber 62′ can in turn be delimited by discs rotating during operation (separating weir 162, inner weir disc 1512 and outer siphon disc 1513) and form a kind of siphon in the region of this chamber 62′.

The heavier of the two liquid phases Lh is thus conducted via the separating weir 162 and then through the respective pressure chamber 62′ and discharged from the respective discharge chamber 163 in the respective blind hole 151′ via one of the discharge pipes 161 in each case.

Depending on the pressure applied by the gas in the pressure chamber 62′, the separation diameter Dz of the two liquid phases Ll, Lh in the bowl 1 is influenced. At a higher gas pressure, the separation diameter Dz is reduced, while the separation diameter Dz increases as the pressure decreases. The pond depth Dt is independent of the gas pressure in this case.

In a fifth exemplary embodiment variant for a three-phase decanter for separating 3 phases (solid/liquid/liquid), the heavier of the two liquid phases Lh is discharged via a weir disc 1518 of a passage opening 151. A separating weir 162 is connected upstream of the passage opening 151.

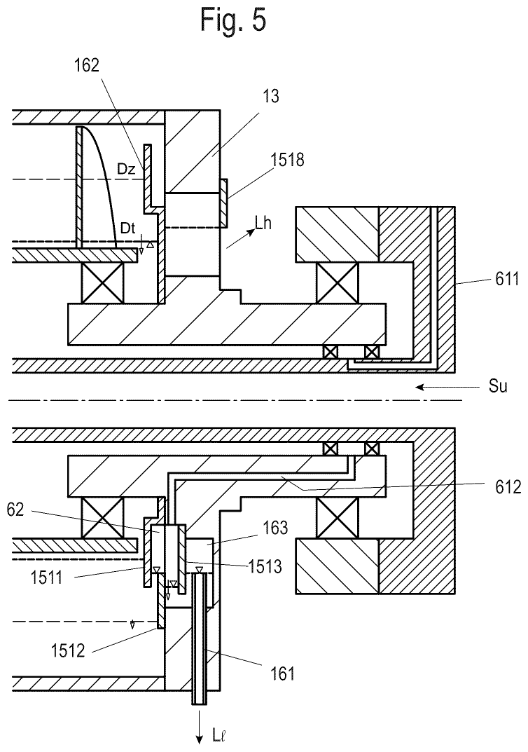

The lighter of the two liquid phases is passed through a pressure chamber 62′ with the gas supply line 612 at the discharge chamber 163 or here at the blind hole 151′ (FIG. 5), and discharged via one of the discharge pipes 161. Depending on the pressure imposed by the gas in the respective pressure chamber 62′, both the pond depth Dt of the two liquid phases Ll, Lh in the bowl 1 and the separation diameter Dz are influenced. At a higher gas pressure, the pond depth Dt increases and the separation diameter Dz increases, while the pond depth Dt and the separation diameter Dz decrease when the pressure decreases.

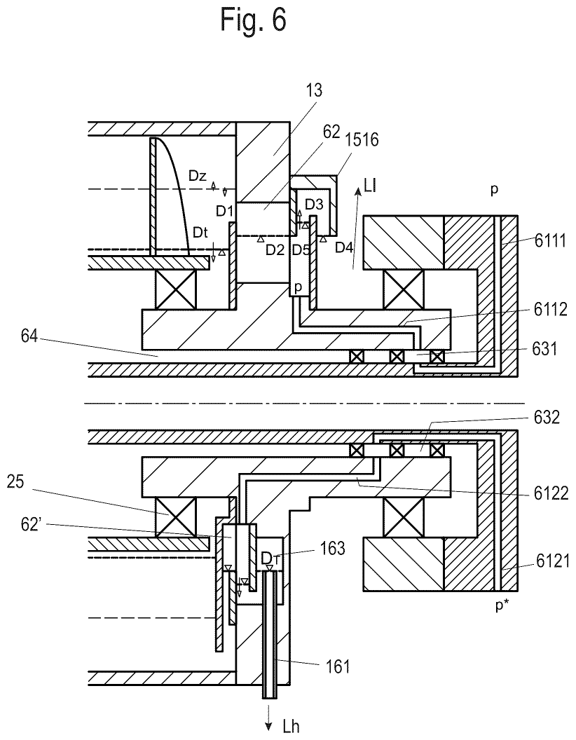

In a sixth embodiment variant for a three-phase decanter for separating 3 phases (solid/liquid/liquid), both liquid phases are passed through two different pressure chambers 62, 62′ (FIG. 6). The lighter of the two liquid phases Ll is discharged as in FIG. 1, whereas the heavier liquid phase Lh is discharged as in FIG. 4 via a discharge pipe 161 from a chamber 63, which is preceded by a pressure chamber 62′.

At least two pressure chambers 62, 62′ are provided for the discharge of both the light and the heavy fluid phases Ll, Lh. These are fed through separate fluid lines 6111, 6112; 6121, 6122 with two rotary feedthroughs 631, 632. In this way, different gas pressures can be set in the chambers 62, 62′.

The effect of the two pressures on the pond depth and separation diameter is the same as in the previous explanations. By increasing the pressure in the chamber 62 to the light phase Ll, for example, the pond depth can be increased. At the same time, the separation diameter Dz increases. The increase in the separation diameter Dz can be compensated for by increasing the pressure in chamber 62′ to the heavy phase Lh; this higher pressure reduces the separation diameter Dz.

It would also be possible, with a similarly positive effect, to attach functional discs such as weir discs or siphon discs to the screw 2 instead of the bowl 1, as the latter has approximately the same rotational speed as the bowl from an energy point of view. The pressure could then be supplied via a fluid supply line 61 with a line section 611 in the frame 7, a rotary feedthrough 63 and line section(s) 612 in the screw 2 into a pressure chamber 62 in the screw 2, which rotates at the screw speed (not shown). With the usually selected low differential speeds between bowl 1 and screw 2, for example between 1 and 40 rpm, the resulting friction losses between the functional discs and the liquids remain low.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

Bowl 1
Cylindrical section 11
Conical section 12
Bowl cover 13
Radially extending section 131
Axially extending sections 132, 133
Solids discharge 14
Liquid drain 15, 16
Weir openings 151
Blind hole 151′
Siphon 1510
Siphon disc 1511
Weir discs 1512, 1514
Siphon disc 1513
Axial wall 1515
Ring siphon 1516
Ring cup 1517
Overflow weir 1518
Gap 15111
Discharge pipe 161
Separating weir 162
Discharge chamber 163
Bowl bearing 17
Screw 2
Cylindrical section 21
Conical section 22
Screw body 23
Screw helix 24
Screw bearing 25
Feed pipe 3
Distributor 4
Separation chamber 5
Device 6
Fluid supply line 61
Line sections611,612; 6111,6112; 6121,6122
Pressure chamber 62, 62′
Pressure chamber sections 62a, 62b
Rotary feedthrough 63, 631,632
Annular gap 64
Mechanical seals 65, 66
Frame 7
Axis of rotation A
Diameter D1, D2, D3, D4, D5, Ds, Dr
Pond depth Dt
Separation diameter Dz
Diameter D1, D2, D3, D4, D5, Ds, Dr
Liquid phases L, Ll, Lh
Torque M1, M2
Rotor R
Solid phase S
Suspension Su
Shaft W1, W2
Pressure P

1-27. (canceled)

28. A solid bowl centrifuge comprising:
a rotor with a bowl configured to rotate about an axis of rotation during operation of the solid bowl centrifuge, wherein the rotor include which has an inlet for a suspension to be processed in a centrifugal field and a separation chamber in which a screw, which is configured to rotate during the operation of the solid bowl centrifuge, is arranged;
a solid material discharge configured to discharge a solids phase;
at least one liquid outlet configured to discharge at least one liquid phase,
wherein the at least one liquid outlet has a device configured to influence a pond depth in the separation chamber or a diameter of a separation zone in the separation chamber,
wherein the device has one or more pressure chambers, into each of which a fluid supply line opens, via which a gas pressure in a respective one of the one or more pressure chambers is influenceable in order to apply the gas pressure in the respective one of the one or more pressure chambers to at least one liquid surface of draining liquid phase to influence the diameter of the pond depth or the diameter of the separation zone in the bowl during operation of the solid bowl centrifuge to adjust the diameter of the pond depth or the diameter of the separation zone in the bowl in a controlled or regulated manner,
wherein the one or more pressure chambers are formed in the rotor, and
wherein one or more functional discs are arranged in a region of one of more pressure chambers, wherein all of the one or more functional discs rotate with the rotor during operation.

29. The solid bowl centrifuge of claim 28, wherein the one or more functional discs are connected in a rotationally fixed manner to the bowl or to the screw so that the one or more functional discs rotate with the bowl or with the screw during operation of the solid bowl centrifuge.

30. The solid bowl centrifuge of claim 28, wherein the one or more functional discs are ring segments or circumferentially closed rings.

31. The solid bowl centrifuge of claim 28, wherein the one or more pressure chambers are bounded on all sides only by elements rotating with the rotor during operation of the solid bowl centrifuge.

32. The solid bowl centrifuge of claim 28, wherein the solid bowl centrifuge is a two-phase solid bowl centrifuge and the at least one liquid outlet is a single liquid outlet for a single liquid phase.

33. The solid bowl centrifuge of claim 28, wherein the solid bowl centrifuge is a three-phase solid bowl centrifuge and that at least one liquid outlet includes first and second liquid outlets respectively configured to discharge a lighter liquid phase and a heavier liquid phase.

34. The solid bowl centrifuge of claim 28, wherein the at least one liquid outlet has a weir with one or more weir openings and the one or more pressure chambers are associated with the weir.

35. The solid bowl centrifuge of claim 28, wherein the bowl has a bowl cover, a plurality of the weir openings are provided in the bowl cover, and a first siphon disc extending from radially inwards to outwards into a region of the weir openings is connected upstream of the one or more weir openings as one of the one or more functional discs.

36. The solid bowl centrifuge of claim 28, wherein the fluid supply line has at least two line sections, wherein one of the at least two line sections is formed in a non-rotating region and another one of the at least two line sections is formed in the bowl or screw of the rotor and opens into the one or more pressure chambers in the rotor.

37. The solid bowl centrifuge of claim 36, wherein the at least two line sections of the fluid supply line are connected to one another via a rotary feedthrough.

38. The solid bowl centrifuge of claim 37, wherein the rotary feedthrough is an annular gap between the rotor and a frame of the solid bowl centrifuge.

39. The solid bowl centrifuge of claim 37, wherein the rotary feedthrough is an annular chamber and has one or more mechanical seals.

40. The solid bowl centrifuge of claim 33, wherein
the first liquid outlet for the lighter liquid phase is assigned one of the one or more pressure chambers into which the respective fluid supply line opens in the rotor, or
the second liquid outlet for the heavier liquid phases is assigned one of the one or more pressure chambers into which the respective fluid supply line opens in the rotor.

41. The solid bowl centrifuge of claim 33, wherein
the first liquid outlet for the lighter liquid phase is assigned one of the pressure chambers into which the respective fluid supply line opens in the rotor, or
the second liquid outlet for the heavier liquid phases is assigned a discharge pipe with which the heavier phase is dischargeable from the bowl.

42. The solid bowl centrifuge of claim 33, wherein
one of the one or more pressure chambers into which the respective fluid supply line in the rotor opens is assigned to the second liquid outlet for the heavier liquid phases, and
the first liquid outlet for the lighter liquid phases is assigned one of the discharge pipes with which the heavier phase is dischargeable from the bowl.

43. The solid bowl centrifuge of claim 28, wherein one of the one or more pressure chambers and a ring siphon, which is provided in sections or revolves, is assigned to one or more weir openings in each case and has a ring cup opening radially inwards, and an outer siphon disc, an radially outer section of which dips into the ring cup.

44. The solid bowl centrifuge of claim 43, wherein the outer siphon disc is a functional disc rotating with the bowl or screw during operation of the solid bowl centrifuge.

45. The solid bowl centrifuge of claim 43, wherein the ring cup of the ring siphon is bounded in an axial direction by two weir discs extending radially from an outside to am inside and which rotate with the bowl or the screw during operation of the solid bowl centrifuge.

46. The solid bowl centrifuge of claim 43, wherein the bowl has a bowl cover with a plurality of the weir openings, the one or more pressure chambers has first pressure chamber sections inside a respective one of the plurality of weir openings and a circumferential annular pressure chamber section adjoining the first pressure chamber sections axially outwards, which connects the first pressure chamber sections and which is formed circumferentially on an inside on a side of an outer siphon disc directed towards the weir openings and radially on an outside towards the ring cup.

47. The solid bowl centrifuge of claim 46, wherein the fluid supply line opens into the circumferential annular pressure chamber section so that a single fluid supply line is suppliable with gas under pressure to an entirety of the one or more pressure chambers.

48. The solid bowl centrifuge of claim 28, wherein the bowl has a bowl cover, a plurality of the weir openings are provided in the bowl cover, a part of the plurality of weir openings is closed at one axial end as a blind hole and is configured as a discharge chamber, wherein a discharge pipe configured to discharge the liquid from the bowl opens into each of the discharge chambers.

49. The solid bowl centrifuge of claim of claim 48, wherein one of the one or more pressure chambers is assigned to each of the discharge chambers in the weir openings.

50. The solid bowl centrifuge of claim 48, wherein another part of the weir openings is configured as passage openings.

51. The solid bowl centrifuge of claim 48, wherein by an arrangement of a respective separating weir in such a way that a lighter liquid phase of the at least one liquid phase is conductible into the respective discharge chamber into which the discharge pipe configured to discharge liquid from the bowl opens.

52. The solid bowl centrifuge of claim 48, wherein by an arrangement of a respective separating weir such that a heavier liquid phase of the at least one liquid phase is conductible into the respective discharge chamber into which the discharge pipe configured to discharge liquid from the bowl opens.

53. The solid bowl centrifuge of claim 48, wherein a plurality of the plurality of weir openings are arranged circumferentially distributed on an imaginary circle in the bowl cover, wherein one of the separating weirs is assigned to each second or third opening.

54. A method for operating a solid bowl centrifuge, the method comprising:
providing a solid bowl centrifuge, which comprises
a rotor with a bowl configured to rotate about an axis of rotation during operation of the solid bowl centrifuge, wherein the rotor include which has an inlet for a suspension to be processed in a centrifugal field and a separation chamber in which a screw, which is configured to rotate during the operation of the solid bowl centrifuge, is arranged;
a solid material discharge configured to discharge a solids phase;
at least one liquid outlet configured to discharge at least one liquid phase,
wherein the at least one liquid outlet has a device configured to influence a pond depth in the separation chamber or a diameter of a separation zone in the separation chamber,
wherein the device has one or more pressure chambers, into each of which a fluid supply line opens, via which a gas pressure in a respective one of the one or more pressure chambers is influenceable in order to apply the gas pressure in the respective one of the one or more pressure chambers to at least one liquid surface of draining liquid phase to influence the diameter of the pond depth or the diameter of the separation zone in the bowl during operation of the solid bowl centrifuge to adjust the diameter of the pond depth or the diameter of the separation zone in the bowl in a controlled or regulated manner,
wherein the one or more pressure chambers are formed in the rotor, and
wherein one or more functional discs are arranged in a region of one of more pressure chambers, wherein all of the one or more functional discs rotate with the rotor during operation; and
regulating a separation process of the solid bowl centrifuge by adjusting a gas pressure in the one or more pressure chamber, into which a gas is introduced, which is fed through a rotary feedthrough into the rotor of the bowl and then into a respective one of the one or more pressure chambers.
